(19) United States
(12) Patent Application Publication
(10) Pub. No.: US 2008/0253958 A1
(43) Pub. Date: Oct. 16, 2008

(54) PRODUCTION OF HIGH-PURITY TITANIUM MONOXIDE AND CAPACITOR PRODUCTION THEREFROM

(76) Inventors: Colin G. McCracken, Sinking Spring, PA (US); Scott M. Hawkins, Fleetwood, PA (US)

Correspondence Address: DUANE MORRIS, LLP;IP DEPARTMENT, 30 SOUTH 17TH STREET, PHILADELPHIA, PA, 19103-4196, US

(21) Appl. No.: 11/939,062

(22) Filed: Nov. 13, 2007

Related U.S. Application Data
(63) Continuation-in-part of application No. 11/560,213, filed on Nov. 15, 2006.

(51) Int. Cl. C01G 23/04

(52) U.S. Cl. 423/609

(57) ABSTRACT

The present invention relates to high-purity titanium monoxide powder (TiO) produced by a process of combining a mixture of titanium suboxides and titanium metal powder or granules; reacting the mixture at a temperature above about 1200° C.; and fragmenting the body to form TiO particles suitable for application as e.g., capacitors. The TiO product is unusually pure in composition and crystallography, highly dense, and can be used for capacitors and for other electronic applications. The method of production of the TiO is robust, does not require high-purity feedstock, and can reclaim value from waste streams associated with the processing of TiO electronic components.

### CROSS REFERENCE TO RELATED APPLICATIONS

This application is a continuation-in-part of application Ser. No. 11/560,213, filed Nov. 15, 2006.

### FIELD OF THE INVENTION

The present invention relates to methods of producing titanium monoxide powders of high purity, and the use of such titanium monoxide powders in the production of valve devices, i.e., capacitors.

### BACKGROUND OF THE INVENTION

Electrical devices, such as power supplies, switching regulators, motor control-regulators, computer electronics, audio amplifiers, surge protectors, and resistance spot welders often need substantial bursts of energy in their operation. Capacitors are energy storage devices that are commonly used to supply these energy bursts by storing energy in a circuit and delivering the energy upon timed demand. Typically, capacitors contain two electrically conducting plates, referred to as the anode and the cathode, which are separated by a dielectric film.

Commercial capacitors attain large surface areas by one of two methods. The first method uses a large area of thin foil as the anode and cathode. The foil is either rolled or stacked in layers. In the second method, a fine powder is sintered to form a single slug with many open pores, giving the structure a large surface area. Both of these methods need considerable processing in order to obtain the desired large surface area. In addition, the sintering method results in many of the pores being fully enclosed, and thus inaccessible to the dielectric.

In order to be effective as an energy storage device, a capacitor should have a high energy density (watt-hours per unit mass), and to be effective as a power delivering device a capacitor should have a high power density (watts per unit mass). Conventional energy storage devices tend to have one, but not both, of these properties. For example, lithium ion batteries have energy densities as high as 100 Wh/kg, but relatively low power densities (1-100 W/kg). Examples of energy storage devices with high power density are RF ceramic capacitors. Their power densities are high, but energy densities are less than 0.001 Wh/kg. The highest energy capacitors available commercially are the electrochemical supercapacitors. Their energy and power densities are as high as 1 Wh/kg and 1,000 W/kg, respectively.

A good capacitor geometry is one in which the dielectric is readily accessed electrically, that is, it has a low equivalent series resistance that allows rapid charging and discharging. High electrical resistance of the dielectric prevents leakage current. A good dielectric, therefore, has a high electrical resistance which is uniform at all locations. Additionally, long-term stability (many charging-discharging cycles) is desired. Conventionally, dielectrics tend to become damaged during use.

Titanium (Ti) metal can be anodized to create a dielectric (TiO₂) layer on its surface. This TiO₂ layer offers a high dielectric constant, and therefore an opportunity to be used to make solid electrolytic capacitors, similar to tantalum, aluminum, niobium, and more recently niobium (II) oxide (NbO). However, the resulting TiO₂ dielectric layer is relatively unstable, leading to high leakage current and making the Ti-TiO₂ system unsuitable for capacitor applications.

Titanium monoxide (TiO) has been used in the sputtering target industry to make thin film conductive coatings. If the conductivity of this TiO material could be anodized to produce a TiO₂ dielectric surface layer, it may have improved leakage current stability compared to the Ti-TiO₂ system by virtue of the reduced oxygen gradient between TiO₂ and the stable TiO sub-oxide.

An object of the present invention is to produce titanium monoxide powder of high purity and sufficient surface area to meet the requirements of TiO capacitors, and further to the use of such powders in the production of capacitors.

### SUMMARY OF THE INVENTION

The present invention relates to a high-purity titanium monoxide powder, produced by a process (“liquid phase reaction”) comprising:

(a) combining a mixture of e.g., TiO₂,Ti₂O₃ and/or Ti₃O₅ and titanium metal in effective amounts stoichiometrically calculated to yield a product with a fixed atomic ratio of titanium to oxygen, the ratio being preferably close to 1:1;

(b) forming a compact of the mixture by cold isostatic pressing or other appropriate techniques;

(c) exposing the compact to a heat source sufficient to elevate the surface temperature above the melting point of the product titanium monoxide, i.e., greater than about 1885° C. in an atmosphere suitable to prevent uncontrolled oxidation;

(d) allowing the mixture to react exothermically to produce the desired titanium monoxide;

(e) solidifying the mixture to form a solid body of titanium monoxide; and

(f) fragmenting the body to form the desired particle size of titanium monoxide.

In an alternative embodiment, the present invention relates to a high-purity titanium monoxide powder, produced by a solid-state reaction between two titanium-containing compounds. A solid-state reaction involves atomic transfer between two (or possibly more) components, intimately blended together in the correct stoichiometric ratio. Thus, the present invention further relates to a high-purity titanium monoxide (TiO) powder, produced by a process comprising:

a) combining a mixture of (1) a titanium suboxide selected from Ti₂O₃, TiₙO₍₂ₙ₋₁₎, and TiO₂, or mixtures thereof, wherein n is 1-5; and (2) metallic titanium, titanium hydride or mixtures thereof, wherein (1) and (2) are present in powder or granular form;

b) forming a compact of the mixture;

c) reacting the mixture at a temperature above about 1200° C.; and

d) fragmenting the body of material to form the TiO powder.

Capacitors can thereby be produced from titanium suboxide particles, by techniques common to the capacitor industry.

As to the liquid phase reaction route, in preferred embodiments, the weight ratio of TiO₂ to metallic titanium in the mixture is about 1⅔:1, the weight ratio of Ti₂O₃ to metallic titanium in the mixture is about 2⅓:1; and the weight ratio of Ti₃O₅ to metallic titanium in the mixture is about 3:1. The heat source is preferably an electron beam furnace, a plasma-arc furnace, an induction furnace, or an electric resistance furnace.

### BRIEF DESCRIPTION OF THE DRAWINGS

The accompanying drawings illustrate preferred embodiments of the invention as well as other information pertinent to the disclosure, in which:

FIG. 1 is a graph of x-ray diffraction patterns for TiO produced by the liquid phase reaction route;

FIG. 2 is an illustration of an ingot produced by the liquid phase reaction route, reduced to sharp, angular, substantially non-porous individual pieces; and

FIGS. 3-5 are scanning electron micrograph (SEM) images of the reacted materials by solid state reaction.

### DESCRIPTION OF THE PREFERRED EMBODIMENTS

### Liquid Phase Reaction

The present invention relates to a method of producing titanium monoxide powder, which includes combining a mixture of e.g., TiO₂, Ti₂O₃ and/or Ti₃O₅ and titanium metal; forming a compacted bar of the mixture; reacting the mixture at a temperature greater than about 1885° C.; solidifying the reaction products; and fragmenting the solidified body to form the titanium monoxide powder. In a preferred embodiment of the present invention, the weight ratio of TiO₂ to titanium metal is about 1⅔:1.

The present invention also relates to the production of a high-purity titanium monoxide powder produced by this process from excess TiO₂ and titanium metal, with the titanium metal in the form of magnesium or sodium reduced Ti-sponge, or commercially pure titanium powder. In the present invention, the high processing temperature, controlled atmosphere and presence of a liquid state may be exploited to remove major impurities, including iron, aluminum, and various other elements other than oxygen and refractory metals.

The following formula may be useful in identifying possible combinations of stable equilibrium materials anticipated to be effective for the purposes of the present invention: A+B =TiO, where A is Ti, Ti₃O, Ti₂O or Ti₃O₂, or mixtures thereof, and B is Ti₂O₃, TiₙO₍₂ₙ₋₁₎, and TiO₂, or mixtures thereof, wherein n=1-5. In addition, the following formula may be useful in identifying possible combinations of metastable materials anticipated to be effective for the purposes of the present invention: Ti(a)O(b)+Ti(x)O(y)=TiO, where 0(zero)≦b<a and 0(zero)<x<y.

In the testing of the present invention, a mixture of commercially available Ti-sponge and commercially available TiO₂ was blended and formed into a bar by cold isostatic pressing, although other means of compaction and resultant physical forms would also be effective. A 16 pound compact of 37.5% Ti-sponge and 62.5% TiO₂ was prepared.

The compact of TiO₂ and Ti sponge (weight ratio 1⅔:1 ) was fed into the melting region of an electron beam vacuum furnace, where the compact reacted and liquefied when heated by the electron beam, with the liquid product dripping into a cylindrical, water-cooled copper mold. When the electron beam initially struck the compact, melting immediately took place, with only a small increase in chamber pressure. A production rate of 20 pounds an hour was established.

While an electron-beam furnace was used in this experiment, it is anticipated that other energy sources capable of heating the materials to at least 1885° C. could also be used, including, but not limited to, cold crucible vacuum induction melting, plasma inert gas melting, and electrical impulse resistance heating.

The resultant ingot was allowed to cool under vacuum, and the apparatus was vented to atmosphere. Samples were taken from the top one inch of the ingot (the “top” samples), while “edge” samples were taken from lower mid-radius locations in the ingot.

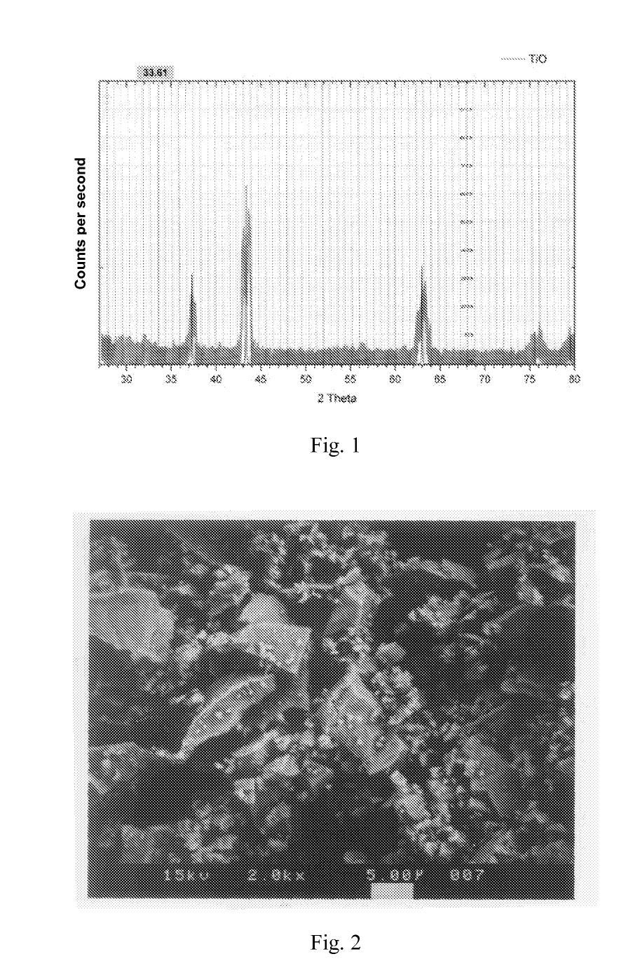

Subsequent analysis of the product TiO samples by x-ray diffraction showed a “clean” pattern for TiO, with no additional lines attributable to titanium metal or TiO₂. In FIG. 1 the x-ray diffraction pattern is shown for TiO produced by the present invention. No peaks other than TiO were seen in the 2-Θ 25-80° range, which represents a successful creation of TiO via liquid-phase reaction in the electron beam furnace.

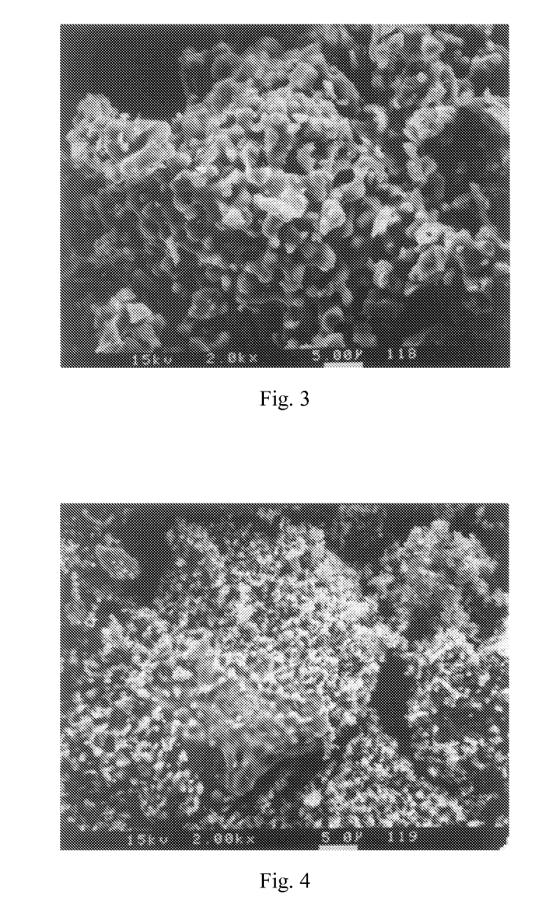

The ingot was then degraded to powder by conventional crushing, grinding and milling techniques. The resultant TiO powder is solid and angular, with an irregular shape (see FIG. 2).

The process of the present invention also serves to recover TiO values from waste streams associated with production of powder-based TiO products, since the refining action of the present invention can effectively remove most contaminants, even when such contaminants are present as fine or micro-fine powders or particles.

The formation of titanium monoxide by melt phase processing lends itself to the recovery and remelting of titanium monoxide solids, including but not limited to powders, chips, solids, swarf (fine metallic filings or shavings) and sludges. Off-grade powder, recycled capacitors and powder production waste are among the materials that can be reverted to full value titanium monoxide by this process.

### Solid State Reaction

In experiments, one component contains excess oxygen, while the other component has a net oxygen deficiency. The reaction was carried out at an elevated temperature but below the melting point of the components. Solid-state reactions can be carried out in vacuum, inert atmosphere, or an atmosphere that promotes oxygen transfer such as hydrogen or ammonia gas. The advantages of this type of reaction are tight control over the final stoichiometry and density changes that result from phase transformations. For capacitor applications, high surface area is a desired result. Densification during reaction results in a net gain in the material's surface area.

In order to reduce operating costs, solid-state reactions are usually performed at the lowest possible temperature and the shortest possible time that ensures complete reaction of the components. Additional time results in densification of the sample. Since solid-state reactions rely on atomic mobility, particle size is critical in determining the reaction rate. The smaller the average particle size, the less energy is required to complete the reaction.

Crystallography was tested by X-Ray diffraction (XRD) on a Phillips XRG 3100 retrofitted with an Inel XRG 3000, 3.0 kW single-phase x-ray generator, copper x-ray tube and Norelco goniometer with detector. Powder was adhered to a glass slide with vacuum grease. Theoretical XRD patterns were generated utilizing data from Pearson's Handbook of Crystallographic Data for Intermetallic Phases. Diffraction patterns were recorded on a paper chart recorder and scanned for use in scientific graphing and analysis software. Imaging was performed on an ISI-SR-50 scanning electron microscope (SEM). All solid-state reactions were performed in a Brew furnace under vacuum. This furnace is capable of high temperature (+1600° C.) and high vacuum.

Raw materials (listed in Table 1, below) for the solid-state TiO reaction consisted of excess TiO₂, titanium metal and titanium hydride (TiH₂), and Ti₂O₃ produced in the EB furnace. The titanium metal was in the form of magnesium reduced Ti-sponge, or commercially pure (CP) titanium powder. Ti₂O₃ was reacted in the EB furnace using CP titanium and TiO₂ and sized by mortar and pestle. Compacts were made with the hydraulic lab press and a 5 mm hand press.

The following equations (shown in Table 2, below) describe the theoretical reactions necessary to produce TiO with the starting materials listed in Table 1. When using titanium hydride, hydrogen gas is expelled at approximately 500° C., leaving titanium metal. There was essentially no difference in the reaction whether Ti or TiH₂ was used. TiH₂ was converted to Ti at a temperature below the solid-state reaction temperature. The advantage to using a hydride for the reaction was a lower starting density, which resulted in additional densification and more surface area in the TiO. The reduction in density was calculated based on the density and amounts of the starting material and the theoretical density of the finished product, assuming there is little change in the total volume of the compact. Theoretical density changes are calculated for the four reactions listed. Density values were obtained from the Handbook of Chemistry and Physics for most of these materials except for Ti₂O₃, which was obtained from PowderCell for Windows, V2.04.

TABLE 1

| | Density |
|---|---|
| Material | (g/cm³) |
| Ti | 4.50 |
| TiH₂ | 3.90 |
| Ti₂O₃ | 4.57 |
| TiO | 4.93 |
| TiO₂ | 4.26 |

TABLE 2

| | Reduction in |
|---|---|
| Equation | Density |
| TiH₂ + TiO₂→ 2 TiO + H₂ | 19.6% |
| Ti + TiO₂→ 2 TiO | 13.3% |
| TiH₂ + Ti₂O₃→ 3 TiO + H₂ | 12.1% |
| Ti + Ti₂O₃→ 3 TiO | 8.3% |

Several mixtures of TiH₂ (−325 mesh) and TiO₂(d50 of 14 μm) were made ranging from 25% to 45% TiH₂by weight. These blends were dry mixed, compacted, and reacted in the Brew furnace under vacuum between 950° C. and 1300° C. for 10 minutes to 4 hours. Reactions were not complete at 950° C. up to 4 hours, comprising of Ti₂O₃, Ti₂O and TiO, as seen by XRD analysis. At 1300° C., reaction to TiO was complete at 4 hours, but not 10 minutes. Mixtures of 35% and 45% TiH both produced only TiO as the finished material. The mixture containing 25% TiH₂ included Ti₂O₃ and TiO in the final product, indicating that that excess oxygen is present. Since TiH₂ dehydrides to Ti prior to reacting, these same parameters would work for a mixture of Ti metal and TiO₂.

A similar result was seen for a mixture of 26% TiH and 74% Ti₂O₃. Reaction under vacuum at 1100° C. for 3 hours was incomplete to TiO, with large areas of under-reacted material. At 1300° C. for 3 hours, the reaction was complete with TiO being the only phase identified by XRD.

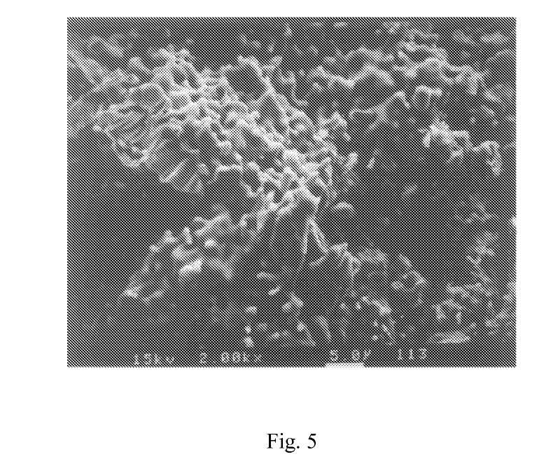

SEM images (FIGS. 3-5) show a mixture of TiH₂ and TiO₂, dry blended, compacted, and reacted under vacuum at different temperatures and times. Material reacted at 1200° C. for 3 hours (FIG. 3) is very similar in appearance to material reacted at 1400° C. for only 10 minutes (FIG. 5). The sample reacted at 950° C. for 3 hours (FIG. 4) shows areas where an intermediate reaction is occurring (Ti to Ti₂O for example), but the bulk of the sample is still unreacted. All images are 2000 times magnification.

The small, white particles in FIG. 4 are TiO₂, which is not electrically conductive and therefore would appear bright in the SEM. These bright non-conductive TiO₂ particles are not visible in the other two images. The densification to TiO is evident in FIGS. 3 and 5, creating a sponge-like appearance and increasing porosity.

Thus, the sub-oxide titanium monoxide (TiO) was also successfully created in the solid-state phase. X-ray diffraction confirmed no other phases were present in the material. Solid-state reactions for TiO completed at around 1200-1300° C. in vacuum for 3-4 hours. Reactions at lower temperatures were incomplete, showing combinations of Ti₂O₃, Ti₂O and TiO. The reaction was successfully performed using either Ti or TiH₂ with TiO₂ or Ti₂O₃. Based on the densities, the most desirable starting components to use are TiH₂ and TiO₂ since this will lead to the greatest densification to TiO. The larger the densification, the more porosity and surface area are created.

While the present invention has been described with respect to particular embodiment thereof, it is apparent that numerous other forms and modifications of the invention will be obvious to those skilled in the art. The appended claims and this invention generally should be construed to cover all such obvious forms and modifications, which are within the true spirit and scope of the present invention.

What is claimed is:

1. A high-purity titanium monoxide (TiO) powder, produced by a process comprising:
a) combining a mixture of (1) a titanium suboxide selected from Ti₂O₃, TiₙO₍₂ₙ₋₁₎, and TiO₂, or mixtures thereof, wherein n is 1-5; and (2) metallic titanium, titanium hydride or mixtures thereof, wherein (1) and (2) are present in powder or granular form;
b) forming a compact of the mixture;
c) reacting the mixture at a temperature above about 1200° C.; and
d) fragmenting the body of material to form the TiO powder.

2. The titanium monoxide powder as recited in claim 1, wherein the weight ratio of TiO₂ to metallic titanium in the mixture is about 1⅔:1.

3. The titanium monoxide powder as recited in claim 1, wherein the weight ratio of Ti₂O₃ to metallic titanium in the mixture is about 2⅓:1.

4. The titanium monoxide powder as recited in claim 1, wherein the temperature is about 1200-1300° C.

5. The titanium monoxide powder as recited in claim 1, wherein the process takes place in vacuum.

6. The titanium monoxide powder as recited in claim 1, wherein the process takes place in inert atmosphere.

7. The titanium monoxide powder as recited in claim 1, wherein the process takes place in an atmosphere that promotes oxygen transfer.

8. The titanium monoxide powder as recited in claim 7, wherein the atmosphere includes hydrogen.

9. The titanium monoxide powder as recited in claim 7, wherein the atmosphere includes ammonia gas.

10. A method of producing titanium monoxide (TiO) powder which comprises:
a) combining a mixture of (1) a titanium suboxide selected from Ti₂O₃, TiₙO₍₂ₙ₋₁₎, and TiO₂, or mixtures thereof, wherein n is 1-5; and (2) metallic titanium hydride or mixtures thereof, wherein (1) and (2) are present in powder or granular form;
b) forming a compact of the mixture;
c) reacting the mixture at a temperature above about 1200° C.; and
d) fragmenting the body of material to form the TiO powder.

11. The method as recited in claim 10, wherein the weight ratio of TiO₂ to metallic titanium in the mixture is about 1⅔:1.

12. The method as recited in claim 10, wherein the weight ratio of Ti₂O₃ to metallic titanium in the mixture is about 2⅓:1.

13. The method as recited in claim 10, wherein the temperature is about 1200-1300° C.

14. The method as recited in claim 10, wherein the process takes place in vacuum.

15. The method as recited in claim 10, wherein the process takes place in inert atmosphere.

16. The method as recited in claim 10, wherein the process takes place in an atmosphere that promotes oxygen transfer.

17. The method as recited in claim 16, wherein the atmosphere includes hydrogen.

18. The method as recited in claim 16, wherein the atmosphere includes ammonia gas.
